(19) United States
(12) Patent Application Publication
(10) Pub. No.: US 2025/0279250 A1
(43) Pub. Date: Sep. 4, 2025

(54) SWITCH ARRANGEMENT

(71) Applicant: Woertz AG, Muttenz (CH)

(72) Inventor: Tamas Onodi, Thalwil (CH)

(21) Appl. No.: 19/066,495

(22) Filed: Feb. 28, 2025

(30) Foreign Application Priority Data
Mar. 1, 2024 (EP) 24161029.4

(51) Int. Cl. H01H 11/00; H01H 1/20

(52) U.S. Cl. CPC H01H 11/00; H01H 1/20

(57) ABSTRACT

A switch arrangement is provided for connecting or disconnecting at least one current-carrying conductor. The switch arrangement comprises an electrical separating element which electrically and mechanically separates a first conductor section and a second conductor section from one another at a separation point. The switch arrangement further comprises a first penetrating contact element to contact the first conductor section without stripping, a second penetrating contact element to contact the second conductor section without stripping, and a contact bridge to electrically connect the first and second penetrating contact elements to one another across the separation point. The switch arrangement also comprises an actuating element for the switch arrangement, wherein an electrical contact of the contact bridge with the first and second penetration contact elements is established or disconnected via the actuating element and thus a connection between the first conductor section and the second conductor section is established or disconnected.

### FIELD OF THE INVENTION

The invention relates to a switch arrangement for at least one current-carrying conductor.

### BACKGROUND OF THE INVENTION

EP 2 780 920 A1 relates to a high-current switch with a first fixed contact, a second fixed contact spaced from the first fixed contact and at least one contact bridge movable relative to the two fixed contacts. Furthermore, a feed device is provided to move the contact bridge from an open position in which the two fixed contacts are not connected to each other, to a closed position in which the contact bridge electrically connects the two fixed contacts to each other. The feed device is also designed to press the contact bridge against the two fixed contacts in the closed position. It is intended that the feed device is designed to be springless, wherein the stiffness of the contact bridge and the feed device in the direction of the pressing force corresponds to a value of at least 50,000 kNmm2, and wherein the lowest natural frequency of the system consisting of the contact bridge and the feed device in the direction of the pressing force is greater than 2000 Hz.

### SUMMARY OF THE INVENTION

According to a first aspect, a switch arrangement is provided for connecting or disconnecting at least one current-carrying conductor. The switch arrangement comprises an electrical separating element which electrically and mechanically separates a first conductor section and a second conductor section from one another at a separation point. The switch arrangement further comprises a first penetration contact element for contacting the first conductor section, a second penetration contact element for contacting the second conductor section, and a contact bridge for electrically connecting the first and second penetration contact elements across the separation point. The switch arrangement also comprises an actuating element for the switch arrangement, wherein an electrical contact of the contact bridge with the first and second penetration contact elements is established or disconnected via the actuating element and thus a connection between the first conductor section and the second conductor section is established or disconnected.

### GENERAL EXPLANATION, ALSO CONCERNING OPTIONAL EMBODIMENTS OF THE INVENTION

A first aspect of the invention relates to a switch arrangement for connecting or disconnecting at least one current-carrying conductor.

In general, electrical switches are used to connect and disconnect voltage or current-carrying parts. The parts (poles) are located, for example, at two cable ends or at cable ends and device connections. Switches are often installed in cable feeds by splitting the cable and installing the switch as a connection between the cable ends. To install switches of this well-known type, the cable ends are usually stripped and connected to the corresponding connection terminals of the switch (serial installation of the switch as a closing and separating element in the current-carrying conductor). The protective sheath is removed and then the insulation is removed from the current-carrying part. Then the bare ends can be connected via a bridge that can be opened. Typically, this connection may only be made in a de-energized state and the assignment of the cable end to the switch terminal must also be observed.

The switch arrangement described here, however, is applicable to current-carrying conductors, whereby the switch can also be installed under voltage. The current-carrying conductor is typically surrounded by an insulating layer (e.g. cable insulation).

The switch arrangement described here comprises an electrical separating element which electrically and mechanically separates a first conductor section and a second conductor section from one another at a separation point. The separating element, for example, represents a physical separation between conductor ends. Several separating elements can also be provided to create the separation between the conductor ends. The first and second conductor sections are kept electrically insulated from one another, for example by the separating element. The first and second conductor sections, for example, touch opposite sides of the electrically insulating separating element.

The switch arrangement comprises a first penetration contact element for contacting the first conductor section (before the separation point) and a second penetration contact element for contacting the second conductor section (after the separation point). A plurality of penetration contact elements can also be provided to contact the first conductor section, and a plurality of penetration contact elements can also be provided to contact the second conductor section. The penetration contact elements, for example, penetrate the insulation layer of the cable core in one movement with the separating element and contact the core conductor, while the separating element cuts through the core conductor. Examples of penetration contact elements are: contact blades, mandrels, (double-sided) contact cutting edges, pointed screws, etc.

A contact bridge is provided in the switch arrangement to electrically connect the first and second penetration contact elements via the separation point. The contact bridge is made of a metal, for example, and is mechanically connected to the penetration contact elements or to the connection elements of the penetration contact elements, which are also made of metal, for example. The contact points can therefore be closed or separated by means of the contact bridge.

The switch arrangement further comprises an actuating element for the switch arrangement, wherein an electrical contact of the contact bridge with the first and second penetration contact elements is established or disconnected via the actuating element and thus a connection between the first conductor section and the second conductor section is established or disconnected.

The actuating element can, for example, be in physical contact with the contact bridge in order to press the contact bridge in the direction of the first and second penetration contact elements themselves or connection points of the penetration contact elements and to mechanically contact the first and second penetration contact elements or connection pieces connected to them.

The actuating element can also be firmly connected to the contact bridge in order to transfer any actuating force acting on the actuating element directly to the contact bridge. The actuator is typically made of electrically insulating material.

Overall, the switch arrangement described here makes it possible, for example, to realize conductor separation with respect to, for example, a single wire or a flat cable in a single device, namely the switch arrangement.

In summary, a switch arrangement is described which, with the aid of separating and contact parts (the above-mentioned separating element or the piercing contact elements), enables the separation of a wire and the contacting of the two separated ends without removing the protective sheath and the wire insulation (stripping-free). The conductor separation and piercing contact of the ends takes place, for example, in one element, i.e. separating elements and contact elements are joined into one entity. The contacts can then be closed or separated by means of the built-in contact bridge.

The separating element can be designed as an insulating separating knife, wherein the insulating separating knife mechanically cuts through the conductor and, after the conductor has been cut through, serves as an insulating partition between the first and the second conductor section. The interruption of the insulated conductor is achieved, for example, by means of the cutting knife, which mechanically cuts through the wire of the insulated conductor. The insulating knife cuts the wire, and the insulating knife itself is then guided as an insulating partition between the two cable ends.

In this design, the cutting blade can be made of hard insulating plastic or of a composite material. The composite material can also comprise ceramic, for example. The separating knife can also have a ceramic blade attached to a plastic body, which acts as a partition between the first and second conductor sections.

The cutting knife can also be equipped with a metal blade, to which an insulating partition (composition of metal blade and insulating partition) is connected. The insulating part of the cutting knife with metal blade is made of plastic or ceramic, for example.

The first and/or the second penetrating contact element is/are, for example, contact blades. In this way, the separated cable ends (first and second cable sections) can be contacted by means of the contact blades without stripping the insulation, as the contact blades penetrate through the insulation of the conductor into the core of a single core or the core of a (multi-core) flat cable. The contact blades thus provide a piercing contact or tapping contact, one before the separation point and one after the separation point. Several contact blades can also be provided for contacting the respective conductor section (before or after the separation point).

The stripping-free contacting of the first or second conductor section is carried out, for example, without removing the protective sheath and the wire insulation before contacting.

The contact points formed in this way are electrically connected or separated from one another by means of the contact bridge when actuated by the insulated actuating element.

The penetration contact elements and the electrically insulating isolating blade can be installed in a cover part of a switch housing which can be pivoted towards a base part of the switch housing.

The current-carrying conductor rests on the base part of the switch housing and is guided through the switch housing. The current-carrying conductor is, for example, the core conductor of a single cable or a core of a flat cable. The current-carrying conductor rests, for example, on the base part, which typically comprises a base plate.

The penetration contact elements and the electrically insulating isolating blade are guided, for example, through an insulating body in the cover part of the switch housing. The insulating body electrically separates the penetration contact elements, such as contact blades or contact screws, from one another.

The described switch arrangement can be designed in such a way that by pressing the cover part against the base part of the switch housing, the current-carrying conductor is severed by the isolating knife at the separation point. By pressing the cover part against the base part of the switch housing, a first contact blade contacts the first conductor section and a second contact blade contacts the second conductor section. By pressing the cover part against the base part, the contact points (between the contact blades and the respective conductor section) are formed in front of and behind the separation point created by the separating blade, which can then be electrically connected again by the contact bridge.

Separating blades with insulated partition and the piercing penetration contact elements (e.g. contact blade or contact screw) together with switch (contact bridge and actuating element) can be placed on the cable in a single mechanically assembled element. This mechanically assembled element can correspond to the cover part described above, which is placed on the base part on which, for example, the individual conductor rests.

The switch housing, for example, is equipped with a lever to press the cover part towards the base part.

This allows a tool-free installation of the switch arrangement if the necessary pressing, e.g. of the cover part against the base part (see above), is carried out by means of the lever. The lever can, for example, be arranged at an anchor point on the lid part and be shaped in such a way that it engages in receptacles on the base part and, during this movement, presses the lid part against the base part.

The contact pressure by means of the lever and the multi-part modular switch arrangement with insulating separating blade make it possible to mount a switch on a current-carrying cable, even when live, without the use of tools.

If such a lever is not provided, the cover part can be pressed against the base part by other means in order to cause the separation or contact of the line. For example, a screw clamp can be used to provide this mechanical pressure.

The separating knife can also be driven into the conductor using a screw to create the separation point.

As regards the penetration contact elements, the first and/or second penetration contact element can (also) be designed as pointed screws which are screwed into the first or second conductor section in order to establish the electrical contact.

For example, the separating blade and the penetration contact elements (piercing parts: here e.g. pointed screws) are movably installed in the switch housing so that they can be pressed into the wire conductor perpendicular to the course of the cable wires by turning the screw. The conductor is split into the first conductor section (before the separation point) and the second conductor section (after the separation point) and the two conductor sections are each contacted by a pointed screw at the respective contact point. When the screws are fully screwed in, the cutting blade cuts the cable and the piercing parts come into contact with the wires of the cable.

The contact bridge is arranged, for example, within the cover part of the switch housing, in such a way that it can, for example, electrically connect the two pointed screws (when the actuating element is actuated).

Instead of using a lever, for example, the cover part can also be fixed to the base part of the switch housing using specially provided screws (i.e. not contact screws or pointed screws) or pressed against the base part of the switch housing.

Alternatively, in other embodiments, the mechanical separation of the current-carrying conductor can be carried out separately using a separation tool; an insulating partition is then introduced as a separating element between the first and second line sections.

For example, in such embodiments, the cutting knife can be dispensed with and the separation of the line (creation of the separation points) can be carried out, for example, by means of cutting through a cable using separate pliers. The first and second cable sections thus formed (before and after the separation point) are then kept insulated from each other, for example by inserting an insulating partition between the cable ends. The cable sections themselves can be contacted with penetration contact elements (e.g. contact blades, pointed screws, etc.), as already described for other embodiments.

As far as the contact bridge is concerned, it can be spring-loaded in the switch arrangements described. The contact bridge can also be equipped with any other reset element. By means of the spring loading of the contact bridge, the contact bridge can be brought into a position in which the first and second penetration contact elements are electrically separated from one another, unless it is brought into a position via the actuating element in which the contact bridge electrically connects the first and second penetration contact elements.

Thus, in a first position of the actuating element (activation position of the switch arrangement), the contact bridge can establish an electrical connection between the first penetration contact element and the second penetration contact element, while in a second position of the penetration contact element (deactivation position), there is no electrical contact between the two penetration contact elements via the contact bridge. The deactivation position is the position in which, for example, no force acts on the contact bridge via the actuating element. The contact bridge is held in the deactivation position, for example by the spring or another return element, until sufficient force is exerted on the contact bridge via the actuating element to move it into the activation position.

For example, when the actuating element changes from the deactivation position to the activation position, the contact bridge is mechanically pressed against the penetration contact elements or connections of these contact elements, while when the actuating element changes from the activation position to the deactivation position, the contact bridge is mechanically removed from the penetration contact elements or their connections, for example by the spring, and is held in this deactivation position.

The actuating element can be a push button on the contact bridge, for example one designed to be insulating.

By exerting force on the push button, an electrical connection can be established between the contact bridge and the first and second penetration contact elements (activation position). This electrical connection is typically made by pressing the contact bridge against connection elements of the contact blades arranged in front of and behind the separation point.

The contact bridge is spring-loaded against the pressure direction of the push button, whereby the contact bridge is mechanically and electrically separated from the first and second penetration contact elements as long as no force is exerted on the push button.

The pressure force can be exerted on the push button by a conventional rocker switch, which is designed, for example, with a large-area rocker (surface switch). By appropriate manual positioning of the rocker switch (see conventional wall switch), the push button can be moved from the activation position (of the switch arrangement) to the deactivation position (of the switch arrangement) and vice versa.

The actuating element can also be a toggle switch, wherein a lever of the toggle switch, when tilted into the activation position, rotates a cam eccentrically so that the cam presses the contact bridge against the penetration contact elements.

The contact bridge is spring-loaded against the pressing force exerted via the cam, whereby when the toggle switch is moved back into a deactivation position, the contact bridge is mechanically and electrically separated from the first and second penetration contact elements or is then separated from the first and second penetration contact elements in the deactivation position.

In the initial position (deactivation position), the cam is mounted eccentrically in a position, for example, such that it does not touch the contact bridge (e.g. the longer diameter of the cam is arranged (approximately) parallel to the contact bridge). When moving from the deactivation position to the activation position, the cam is rotated, for example, into a position in which the longer diameter of the cam is (approximately) perpendicular to the contact bridge and the cam thus mechanically presses the contact bridge against the first and second penetration contact elements or their connections and thus establishes the electrical contact between them. During the transition from the activation position to the deactivation position, the cam is returned to its initial position by eccentric (back) rotation.

Regarding the current-carrying conductor, this can be one core of a multi-core flat cable. This core of the multi-core flat cable, e.g. a phase conductor core, is contacted via the penetration contact elements (contact blades, mandrels, (double-sided) contact cutting edges, pointed screw, etc.) without stripping the insulation. For example, the entire switch arrangement is placed above the flat cable in such a way that exactly one wire (e.g. a specific phase conductor wire) is contacted by the penetration contact elements. The flat cable is placed, for example, on a base part of the switch arrangement in a specific position so that the position of the conductor to be contacted is fixed and known. The base part can be shaped in such a way that the flat cable can only be inserted in the intended orientation.

The current-carrying conductor can also be a core of a round cable.

For example, several round cables can be separated or contacted in parallel as current-carrying conductors, provided that the round cable wires are arranged parallel to each other and are fixed relative to the separating element or the penetration contact elements. The round cable wires can be fixed for separation or contact using a template in which the round cables can be inserted parallel to each other. One separating element or two first and second contact elements per round cable can be provided for separating or contacting the round cables.

Several separating elements, several piercing contact elements and several contact bridges can be provided to switch several current-carrying conductors of a multi-core flat cable.

Each of these current-carrying conductors (for example several phase conductor wires of the flat cable) can be switched separately.

However, it can also be provided that the separation of the first conductor section from the second conductor section and the contacting of the first or second conductor section takes place in one go via a common contacting or separating element.

The common contacting or separating element can be the insulating body described above, which carries both penetration contact elements and at least one separating element.

The switch arrangement can be assembled by applying pressure in one or more stages to the at least one separating element or to the at least one first and second contacting element (e.g. first and second penetration contact element-see above). The pressure required for separation or contact can be exerted simultaneously on the separating element(s) and on the penetration contact elements.

It is also possible to apply pressure selectively to a separately mounted separating element first and then, in a second stage, to the penetration contact elements. To apply the pressure, a screw clamp or a lever element can be used, for example, as described above.

### SHORT DESCRIPTION OF THE DRAWINGS

The drawing serves to illustrate the switch arrangement described above and its handling by means of embodiment examples. In the drawing show:

FIG. 1a-1e schematically show the severing of a wire conductor as a line by means of an insulating cutting blade, as well as the contacting of the line sections thus produced by means of two penetration contact elements (here: contact blade) and a contact bridge in an open (deactivation position) or closed (activation position) position in relation to the penetration contact elements,

FIG. 2 shows schematically a multi-part switch housing with a flat cable, wherein the conductor is severed as a line by an insulating separating blade and the line sections thus produced are contacted by associated penetration contact elements in the form of contact blades by means of a pivoting movement, wherein the contact blades are connected via a contact bridge when a push button is actuated,

FIG. 3a schematically a multi-part switch housing of a switch arrangement with flat cable comparable to FIG. 2, whereby here the insulating separating blade is driven through the core conductor as a line with a screw and the line sections thus produced are contacted by pointed screws instead of contact blades,

FIG. 3b shows schematically a switch arrangement with a toggle switch as the actuating element, wherein an eccentrically mounted cam is rotated by means of a lever of the toggle switch so that it presses the contact bridge against the penetration contact elements,

FIG. 4 shows schematically a sectional view of a switch arrangement similar to that shown in FIG. 2, in which an insulating separating blade and two contact blades are driven through or into the conductor when a cover part is pressed against the base part of the switch housing by means of a lever-assisted pivoting movement,

FIG. 5 shows schematically a switch arrangement in which the cover part of a switch housing is pressed against the base part of the switch housing by means of a screw clamp.

### DESCRIPTION OF EMBODIMENTS BASED ON THE DRAWING

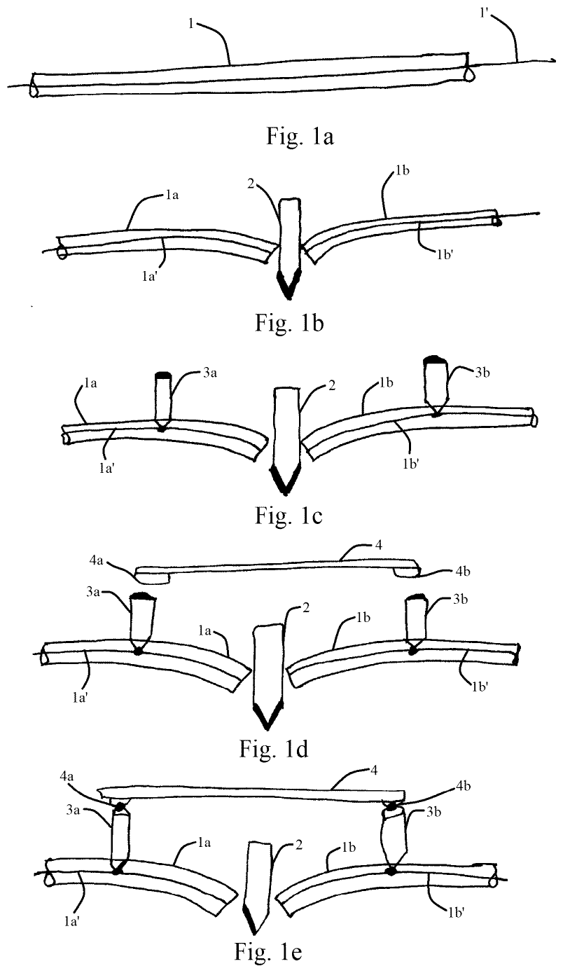

A cable 1 shown schematically in FIG. 1a comprises a core conductor 1′ as a line, which is surrounded by an insulating layer.

As shown schematically in FIG. 1b the cable 1 is divided by a separating knife together with the conductor 1′ at a separation point, whereby a first line section 1a′ and a second line section 1b′ are created in associated cable ends 1a and 1b, respectively.

The thus formed first and second line sections 1a′ and 1b′ are contacted by an associated penetration contact element, here contact blades 3a and 3b, as shown in FIG. 1c. Spikes or pointed screws (double-sided blades, etc.) can also be provided for contacting without stripping the insulation. In this example, the first line section 1a′ in cable end 1a is contacted by a contact blade 3a and the second line section 1b′ in cable end 1b is contacted by a second contact blade 3b.

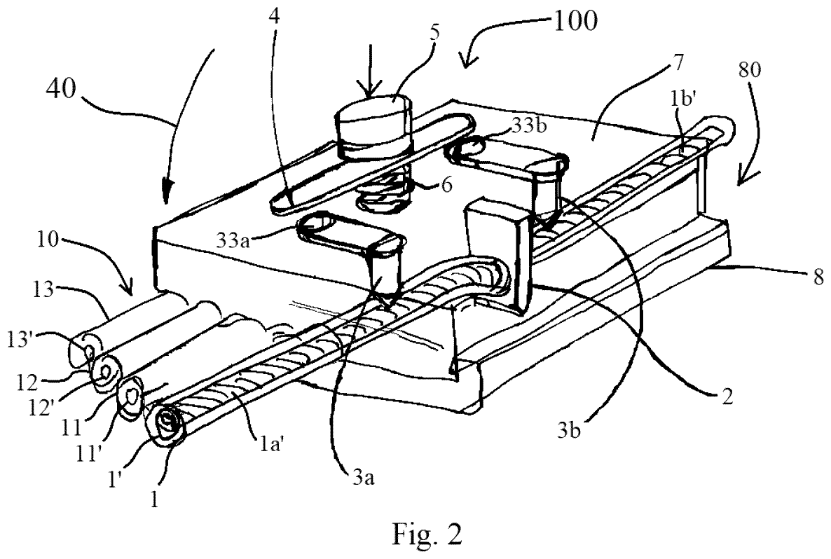

A contact bridge 4 with connection points 4a and 4b is shown in FIG. 1d in an open state, which corresponds to a deactivation position of the switch arrangement (see FIG. 2 et seqq.). In this deactivation position, the contact bridge 4 is electrically and mechanically separated from the contact blades 3a, 3b.

In an activation position, shown in FIG. 1e, the contact bridge 4 is mechanically and electrically connected to the contact blades 3a and 3b, wherein the connection points 4a and 4b are in current-carrying contact with corresponding connections of the contact blades 3a, 3b.

A multi-part switch housing 80 of a switch arrangement 100 with a flat cable 10 passed through, wherein the core conductor 1′ is severed as a line by an insulating separating blade 2 and the line sections 1a′, 1b′ thus produced are contacted by associated contact blades 3a, 3b by means of a pivoting movement 40, is shown in FIG. 2.

The contact blades 3a, 3b are connected via a contact bridge 4 when a push button 5 is pressed.

The switch arrangement 100 is intended to either interrupt or allow a single wire 1 with wire conductor 1′, which represents the current-carrying line to be switched, to pass through.

In order to assemble and use the switch arrangement 100 shown, the conductor 1′ does not have to be de-energized before assembly.

The single core 1 with the core conductor 1′ is a phase conductor core of a flat cable 10, which has at least four further cores 11 to 13 with associated core conductors 11′ to 13′. The wires 11 to 13 can comprise a neutral conductor wire, a protective conductor wire or further phase conductor wires.

The wire conductor 1′ to be switched, like the entire flat cable 10, rests on a base part 8 of the switch housing 80. The bottom part 8 is designed, for example, as a base plate. The switch housing 80 is constructed in two parts and comprises a base part 8 and a cover part 7, which can be pivoted in the pivoting direction 40 relative to the base part and can also be pressed against the base part 8 to separate or contact the conductor 1′.

In the state shown in FIG. 2, the cover part 7 with the contact blades 3a, 3b anchored there, as well as the insulating separating blade 2, is pressed against the base part 8 and thus against the flat cable 10 in such a way that the core conductor 1′ is severed by the insulating separating blade 2. In this fully engaged position of the cover part 7 in the base part 8, the insulating separating blade 2 forms an insulating partition between the line section 1a′ and the line section 1b′ of the core conductor 1′.

The line section 1a′ is contacted by a contact blade 3a, while the line section 1b′ is contacted by a contact blade 3b (tapping contacts or piercing contacts).

The contact blades 3a and 3b are connected to the respective connection elements 33a, 33b of the contact blades 3a and 3b.

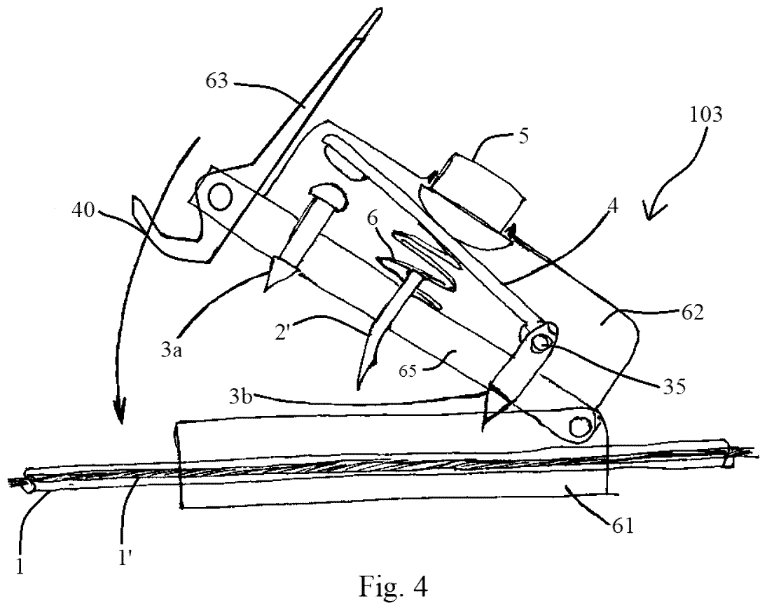

The contact bridge 4 suspended on a spring 6 in the cover part 7 (for example on an insulating body, see FIG. 4) can be pressed against the connection elements 33a and 33b of the contact blades 3a and 3b by means of a push button 5, which here serves as an actuating element of the switch arrangement 100, in order to establish an electrical contact between the contact blades 3a and the contact blades 3b and thus to establish an electrical connection between the line section 1a′ and the line section 1b′. This position corresponds to the activation position of the switch arrangement 100.

The contact bridge 4 is subjected to a restoring force by the spring 6 counter to the direction of displacement or force of the push button 5, so that as soon as no more force is exerted on the push button 5 in the direction of the connection elements 33a and 33b of the contact blades 3a and 3b, the contact bridge returns to a neutral position, which corresponds to a deactivation position of the switch arrangement 100.

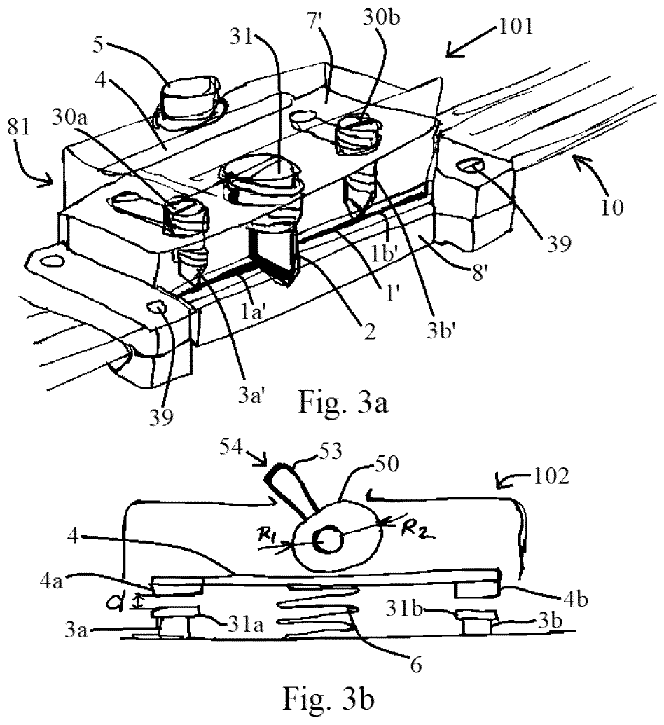

A multi-part switch housing 81 of a switch arrangement 101 with flat cable 10 comparable to FIG. 2, wherein here the insulating separating blade 2 is driven with a screw 31 through the core conductor 1′ as a line and the line sections 1a′, 1b′ produced in this way are contacted by pointed screws 30a, 30b instead of contact blades, is shown schematically in FIG. 3a.

In this embodiment, the insulating separating blade 2 is driven through the core conductor 1′ by means of a screw 31 in order to divide the core conductor 1′ into line sections 1a′ and 1b′. In this embodiment, pointed screws 3a′, 3b′ with screw heads 30a, 30b are used as penetration contact elements. The first pointed screw 3a′ contacts the first line section 1a′ and the second pointed screw 3b′ contacts the second line section 1b′.

In this embodiment, the cover part 7′ of the switch housing 81 is pressed against the base part 8′ of the switch housing 81 by screws 39 in order to achieve the insulating separation or contacting of the conductor 1′ described above and to hold the cover part 7′ and the base part 8′ together.

The function of the push button 5 and the contact bridge 4 corresponds to that described with reference to FIG. 2. The spring as suspension of the contact bridge 4 on an insulating body (see FIG. 4) is not shown in the embodiment according to FIG. 3, but may be present.

A switch arrangement 102 with a toggle switch 54 as actuating element, wherein an eccentrically mounted cam 50 is rotated by means of a lever 53 of the toggle switch 54 so that it presses the contact bridge 4 against the piercing contact elements 31a, 31b, is shown schematically in FIG. 3b.

The toggle switch 54 comprises an eccentrically rotatable cam 50 which can be pivoted via a lever 53 from a deactivation position shown in FIG. 3b (left stop) to an activation position (right stop).

In its neutral position, which is only loaded by the restoring force of the spring 6, the contact bridge 4 has a distance d between the connection points 4a or 4b of the contact bridge 4 and the corresponding connections 31a or 31b of the penetration contact elements (e.g. contact blades 3a, 3b).

The cam 50 is mounted eccentrically above the contact bridge 4. The cam 50 has a first (shorter) radius R1 and a second (longer) radius R2 from its bearing point. The first and second radii R1 and R2 of the cam 50 to the distance d of the contact bridge 4 in the neutral position or deactivation position to the (connecting pieces of the) penetration contact elements establish the following relationship: R2>R1+d.

As soon as the cam 50 is tilted by means of the lever 53 from a deactivation position, in which its diameter (given by the sum of the radii R1+R2) is oriented almost parallel to the contact bridge 4, into an activation position in which the radii R1+R2 are oriented almost perpendicular to the contact bridge 4, the cam displaces the contact bridge 4 in the direction of the connections 31a or 31b of the contact blades 3a and 3b and presses the contact bridge 4 against the connections 31 or 31b—whereby the electrical contact between the contact blades 3a and 3b is closed via the contact bridge 4.

A sectional view of a switch arrangement similar to that shown in FIG. 2, in which an insulating disconnecting blade and two contact blades are driven through or into the core conductor when a cover part is pressed against the base part of the switch housing by means of a lever-assisted pivoting movement, is shown schematically in FIG. 4.

The cable 1 with the conductor 1′ to be contacted rests on the base part 61 (e.g. the base plate).

During the closing movement 40 of the cover part 62 against the base part 61 by pressing the cover part 62 against the base part 61 by means of the lever 63, the core conductor 1′ is on the one hand severed by the insulating separating blade 2′ and on the other hand contacted at line sections before and after the separation point by the contact blades 3a, 3b. The pressing force can be transmitted via the lever in such a way that the lever engages under tension in a receptacle in the base part 61 (not shown).

The contact blades 3a, 3b and the separating blade 2′ are guided through a common insulating body 65, so that an electrical connection between the two contact blades can only be established via the contact bridge 4.

In the embodiment shown in FIG. 4, one of the two contact blades 3a, 3b, namely contact blade 3b, is suspended directly from the contact bridge 4. The contact bridge 4, in turn, is held at the position of the separating blade, i.e. at approximately the same distance from the first and second contact blades 3a, 3b, by means of a spring on the insulating body 65.

If no force is exerted on the push button 5 in the direction of the two contact blades 3a, 3b or their connection pieces (deactivation position), the contact bridge 4 is mechanically and electrically separated from the one contact blade that is not suspended from the contact bridge 4, namely contact blade 3a, whereby the connection along the wire conductor 1′ via the switch arrangement 103 is separated. The restoring force mediated by the spring 6 ensures that the contact bridge 4 does not touch the contact blade 3a or its connecting piece in the deactivation position.

When a force is exerted on the push button 5 in the direction of the two contact blades, the contact bridge 4 contacts the contact blade 3a against the restoring force of the spring 6. The contact bridge thus conducts the current from the contact blade 3a to the contact blade 3b, which is already conductively connected to the contact bridge 4, thereby establishing a connection along the conductor 1′ via the switch arrangement 103.

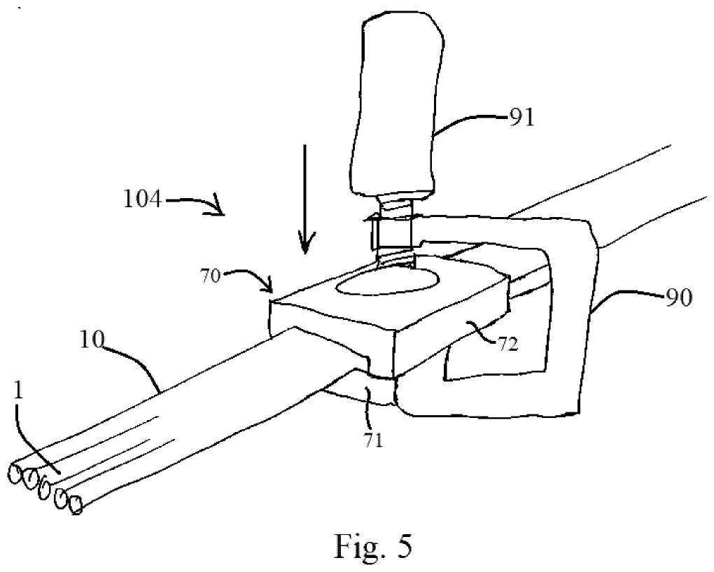

A switch arrangement 104 in which the cover part 72 is pressed against the base part 71 of a switch housing 70 by means of a screw clamp 90 is shown schematically in FIG. 5.

A flat cable 10 with several cable cores 1 is guided through the switch housing 70 and rests on the base part 71 of the switch housing 70. The cover part 72, with the elements described in eg FIGS. 1, 2, 4, is in this embodiment pressed against the base part 71 by means of a screw clamp 90 with a handle 91, along the contact pressure direction indicated by an arrow in FIG. 5, in order to sever one or more flat cable wires on the one hand, eg by means of an insulating separating knife (see eg FIGS. 1, 2, 4) and on the other hand to contact them before and after the separation point thus created.

Thus, in one embodiment, the switch arrangement 104 can be mounted using a screw clamp 90.

1. A switch arrangement for connecting or disconnecting at least one current-carrying conductor, the switch arrangement comprising:
an electrical separating element configured to separate a first conductor section and a second conductor section so the first conductor section and the second conductor section are electrically and mechanically separated from each other at a separation point;
a first penetration contact element around the first conductor section to contact without stripping;
a second penetration contact element around the second conductor section to contact without stripping;
a contact bridge around the first and second penetration contact elements to electrically connect them across the separation point; and
an actuating element for the switch arrangement, wherein an electrical contact of the contact bridge with the first and second penetration contact elements is established or disconnected via the actuating element and thus a connection between the first conductor section and the second conductor section is established or disconnected.

2. The switch arrangement according to claim 1, wherein the separating element is designed as an insulating separating blade, wherein the insulating separating blade mechanically cuts through the conductor and serves as an insulating separating wall between the first and the second conductor sections after the conductor has been cut.

3. The switch arrangement according to claim 2, wherein the separating blade is made of hard insulating plastic or of a composite material or an insulating partition wall adjoins a metallic blade.

4. The switch arrangement according to of claim 1, wherein the first and/or the second penetration contact elements are contact blades.

5. The switch arrangement according to ene of claim 1, wherein the first and/or the second penetration contact elements and the electrically insulating separating blade are installed in a cover part of a switch housing which can be pivoted in the direction of a bottom part of the switch housing, wherein the current-carrying conductor rests on the bottom part of the switch housing and is guided through the switch housing.

6. The switch arrangement according to claim 5, wherein the first and/or the second penetration contact elements and the electrically insulating separating blade are guided through an insulating body in the cover part of the switch housing.

7. The switch arrangement according to claim 5, wherein by pivoting and pressing the pivotable cover part against the bottom part of the switch housing, the current-carrying conductor passed through is severed by the separating blade at the separation point and a first contact blade contacts the first conductor section and a second contact blade contacts the second conductor section.

8. The switch arrangement according to claim 7, wherein the switch housing is equipped with a lever to press the cover part towards the bottom part.

9. The switch arrangement according to claim 1, wherein the mechanical separation of the current-carrying conductor is carried out separately with a separation tool and an insulating intermediate wall is introduced as a separating element between the first and the second conductor sections.

10. The switch arrangement according to claim 2, wherein the separating blade is driven into the conductor by means of a screw in order to produce the separating point and wherein the first and/or second penetration contact elements are pointed screws which are screwed into the first and/or second conductor sections in order to produce the electrical contact.

11. The switch arrangement according to claim 1, wherein the contact bridge is spring-loaded.

12. The switch arrangement according to claim 11, wherein the actuating element is a push button on the contact bridge, wherein an electrical connection of the contact bridge to the first and second penetration contact elements can be established by exerting force on the push button, wherein the contact bridge is spring-loaded against the pressure direction of the push button, whereby the contact bridge is mechanically and electrically separated from the first and second penetration contact elements as long as no force is exerted on the push button.

13. The switch arrangement according to claim 1, wherein the current-carrying conductor is a core of a multi-core flat cable, or wherein the current-carrying conductor is a core of a round cable.

14. The switch arrangement according to claim 1, wherein a plurality of round cables can be disconnected or connected in parallel as current-carrying conductors, provided that the round cable cores are arranged parallel to one another and are fixed relative to the separating element or the first and second penetration contact elements.

15. The switch arrangement according to claim 1, wherein a plurality of separating elements, a plurality of penetration contact elements and a plurality of contact bridges are provided in order to switch a plurality of current-carrying conductors of a multi-core flat cable.

16. The switch arrangement according to claim 1, wherein the separation of the first conductor section from the second conductor section and the contacting of the first and second conductor sections takes place via a common contacting or separating element.

17. The switch arrangement according to claim 1, wherein the stripping-free contacting of the first or second conductor section takes place without removing the protective sheath and the wire insulation before contacting.

18. The switch arrangement according to claim 1, wherein the assembly of the switch arrangement takes place by single or multi-stage exertion of pressure on the separating element or on the first and second contacting elements.

19. The switch arrangement according to claim 11, wherein the actuating element is a toggle switch, wherein a lever of the toggle switch, when tilted into an activation position, eccentrically rotates a cam such that the cam presses the contact bridge against the first and second penetration contact elements, wherein the contact bridge is spring-loaded against the pressing force exerted via the cam and is mechanically and electrically separated from the first and second penetration contact elements when the toggle switch is moved back into a deactivation position.
